(19) United States
(12) Patent Application Publication
(10) Pub. No.: US 2009/0130909 A1
(43) Pub. Date: May 21, 2009

(54) INTERCONNECT DEVICE AND THE ASSEMBLY SAME IS USED THEREIN

(75) Inventors: Victor Zaderej, St. Charles, IL (US); Samuel C. Ramey, Naperville, IL (US); Dennis Berek, Naperville, IL (US); Michael R. Kamarauskas, Bartlett, IL (US)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 11/791,181

(22) PCT Filed: Nov. 17, 2005
(86) PCT No.: PCT/US2005/041655

§ 371 Date: Dec. 4, 2007

(51) Int. Cl. H01R 33/00; H01R 12/00

(52) U.S. Cl. 439/638; 439/61

(57) ABSTRACT

An assembly (118) is provided for mating a sensor (22) to a connector (24). The assembly includes an interconnect device (20, 120) and a housing (174a-174b). The interconnect device has conductive pathways (40, 154) provided thereon. The sensor is mounted on the interconnect device and is in electrical communication with the conductive pathways. The housing generally surrounds a portion of said interconnect device. The housing is formed of two portions which mate together. At least one flow tube (178) is attached to the housing. A gasket seals the sensor to the housing.

This application claims the domestic priority of U.S. provisional application Ser. No. 60/628,586, filed on Nov. 17, 2004, which disclosure is herein incorporated by reference.

### FIELD OF THE INVENTION

This invention is generally directed to an interconnect device which is configured to connect a sensor to a connector. The interconnect device is used in an assembly. The sensor determines flow characteristics or other characteristics of a fluid.

### BACKGROUND OF THE INVENTION

Sensors which incorporate Micro-Electro-Mechanical Systems (MEMS) or a biological Micro-Electro-Mechanical Systems (BioMEMS) are now being used to determine characteristics of a fluid, such as flow rate, temperature, for the presence of biological agents, genetic diseases present in the fluid, infectious agents in the fluid, detection of metals, etc. These types of sensors allow for in field usage, such as on a battlefield, to determine the characteristics of the fluid, such as blood, to allow for the immediate treatment of the condition found as a result of the analysis using the MEMS or BioMEMS.

A sensor that incorporates MEMS is disclosed in U.S. Pat. No. 6,813,964. The sensor is housed in a housing that is formed of a molded plastic during an injection molding process. This process is time consuming and can be difficult to assure proper registration of the MEMS within the housing.

### SUMMARY OF THE INVENTION

One object of the present invention is to provide a low cost way to seal a MEMS, or other measurement type device, in combination with an electrical interconnect device.

Another object of the present invention is to provide an assembly whereby the electrical interconnect device is not in direct contact with the fluid to be introduced into the measurement device.

Yet another object of the present invention is to provide electrical access to the measurement device that has been sealed in an overall assembly.

Briefly, the present invention discloses an assembly for mating a sensor to a connector. The assembly includes an interconnect device and a housing. The interconnect device may formed from a two-shot molded component and has conductive pathways provided thereon. The sensor is mounted on the interconnect device and is in electrical communication with the conductive pathways. The housing generally surrounds a portion of said interconnect device. The housing is formed of two interconnecting portions, which may be hermaphroditic, which mate together. At least one flow tube is attached to the housing. A gasket seals the sensor to the housing.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a top perspective view of an interconnect device which incorporates features in accordance with a first embodiment of the invention;

FIG. 2 is a top perspective view of a first shot which is used to form the interconnect device of FIG. 1;

FIG. 3 is a bottom perspective view of the first shot which is used to form the interconnect device of FIG. 1;

FIG. 4 is a top perspective view of a second shot which is used to form the interconnect device of FIG. 1;

FIG. 5 is a top perspective view of the interconnect device of FIG. 1 having a sensor attached thereto;

FIG. 6 is a perspective view of the interconnect device of FIG. 1 having a sensor attached thereto, shown being presented for mating with a connector;

FIG. 7 is a perspective view of the interconnect device of FIG. 1 having a sensor attached thereto, shown mated to the connector;

FIG. 8 is a top perspective view of an interconnect device which incorporates features in accordance with a second embodiment of the invention, shown mounted in an assembly;

FIG. 9 is a top perspective view of the interconnect device of FIG. 8;

FIG. 10 is a top plan view of the interconnect device of FIG. 8;

FIG. 11 is a top perspective view of the interconnect device of FIG. 8, shown attached to a sensor;

FIG. 12 is a perspective view of a portion of the assembly shown in FIG. 8;

FIGS. 13-15 are perspective views of the interconnect device of FIG. 8 shown being attached to the assembly shown in FIG. 8;

FIG. 16 is a cross-sectional view the assembly shown in FIG. 8, shown mated with a connector;

FIG. 17 is a top perspective view of the interconnect device, shown mounted in an alternate assembly; and

FIG. 18 is a top perspective view of the interconnect device, shown mounted in yet another alternate assembly.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

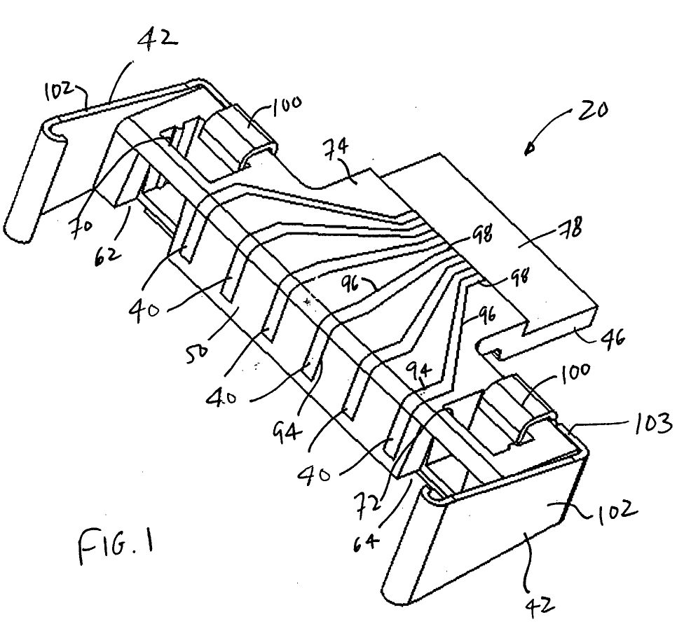

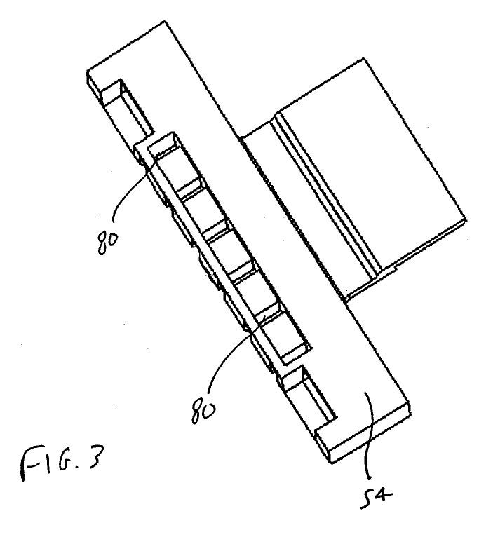

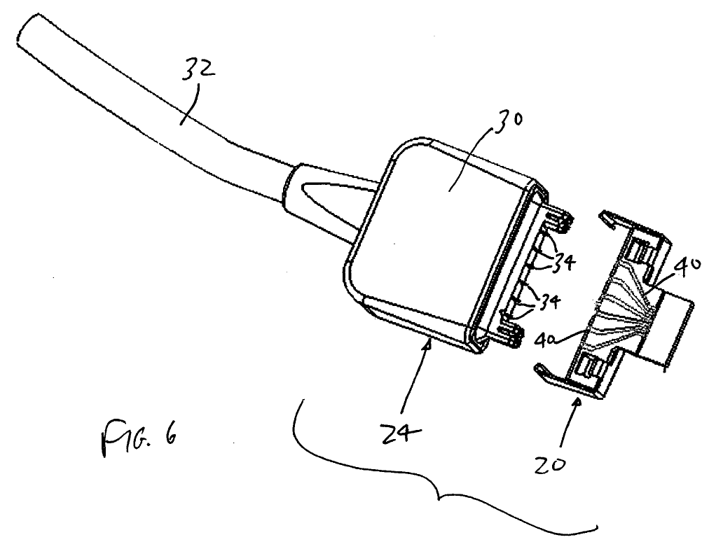

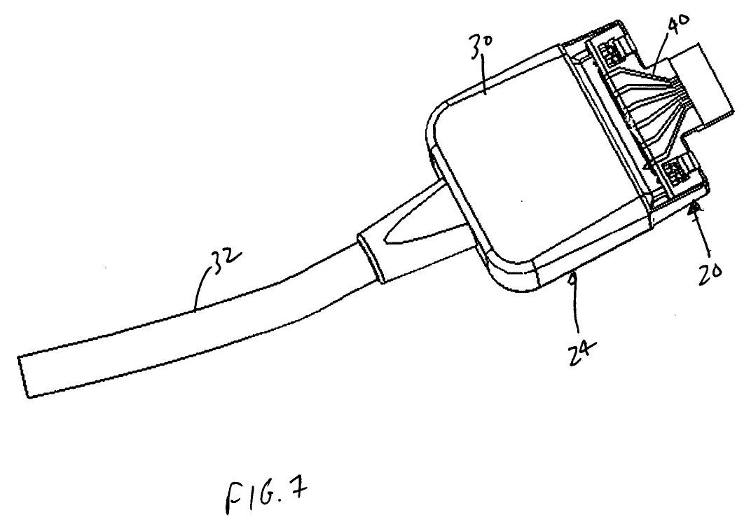

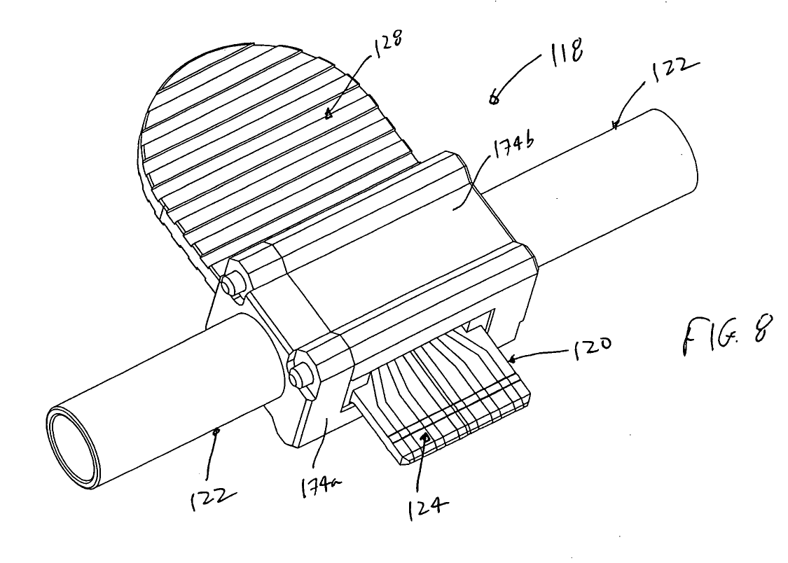

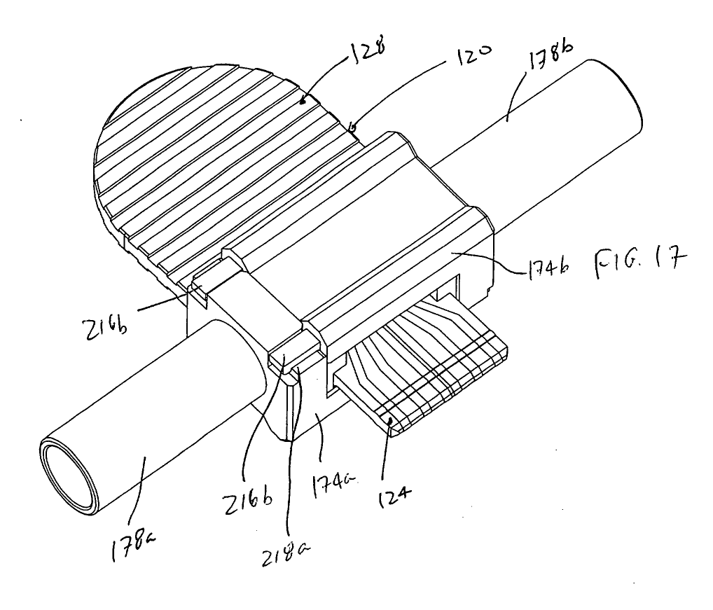

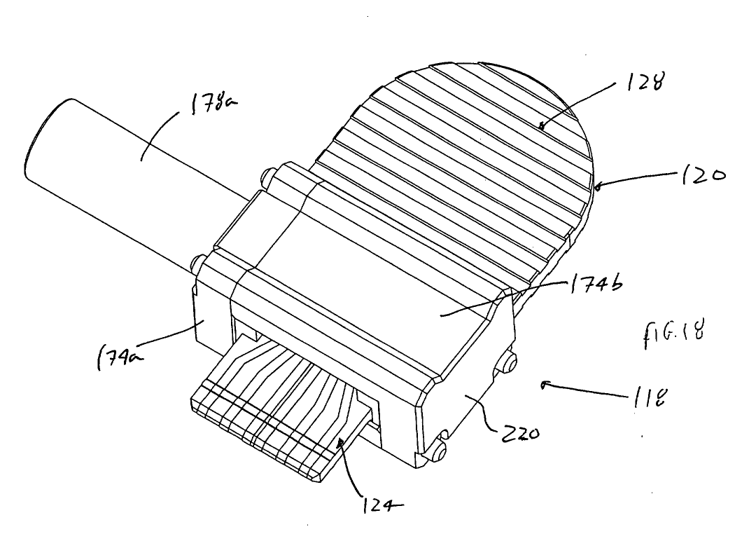

A first embodiment of the present invention is described with relation to FIGS. 1-7 and a second embodiment of the present invention is described with relation to FIGS. 8-16. The first embodiment of the present invention provides an interconnect device 20 and the second embodiment of the present invention provides an interconnect device 120 mounted in an assembly 118. The interconnect device 20 of the first embodiment can be mounted in a like assembly 118. FIGS. 17 and 18 disclose alternate means of forming the assembly 118 and can be used with either embodiment of the interconnect device 20, 120.

In each embodiment, the interconnect device 20, 120 is configured to connect a sensor 22, such as a Micro-Electro-Mechanical Systems (MEMS) or a biological Micro-Electro-Mechanical Systems (BioMEMS), to a connector 24. The sensor 22 is used to determine characteristics of a fluid, such as flow rate, temperature, for the presence of biological agents, genetic diseases present in the fluid, infectious agents in the fluid, detection of metals, etc. While terms such as “upper”, “lower”, “top”, “bottom”, “front”, “rear” and the like are used in describing the first and second embodiments of the invention, it is to be understood that these terms are not limiting with regard to the usage of the first and second embodiments of the invention in relation to the sensor 22 and to the connector 24.

As shown, the sensor 22 has a main body 25 that has a passageway 26 extending therethrough through which fluid can flow. A lip 27 extends from the main body 25 and has a height that is less than the height of the main body 25. The upper surface of the main body 25 and the lip 27 are planar. The sensor 22 includes components, such as a proportional microvalve, pressure sensors, a temperature sensor and calibration electronics, mounted on a silicon substrate. In one embodiment, the sensor 22 can be used to control the rate of the fluid flow through the passageway 26 through means known in the art by measuring the capacitance changes in the fluid flowing through the passageway 26. The sensor 22 can be used to determine characteristics of the fluid in the passageway 26, such as flow rate, temperature, for the presence of biological agents, genetic diseases present in the fluid, infectious agents in the fluid, detection of metals, etc. As shown, the sensor 22 has spaced apart leads 28 provided thereon for interconnection to the interconnect device 20, 120. Such a sensor is shown in U.S. Pat. No. 6,813,964, which disclosure is incorporated herein by reference.

The connector 24 is known in the art and includes a housing 30 having a cable 32 attached thereto and a plurality of terminals 34 within the housing 30. The ends of the terminals 34 extend from the housing 30 and are spaced apart from each other predetermined distances.

The interconnect device 20, 120 is disposable (but mates with a high wear life mating connector 24, i.e., greater than several thousand cycles), is low cost to manufacture, and the parasitic capacitance of the interconnect device 20, 120 is very low (i.e., less than 0.5 pf). The interconnect device 20, 120 is preferably formed by a high cavitation, two-shot molding process and a plating process. The high cavitation, and two-shot molding process keeps the cost of manufacturing the interconnect device 20, 120 low.

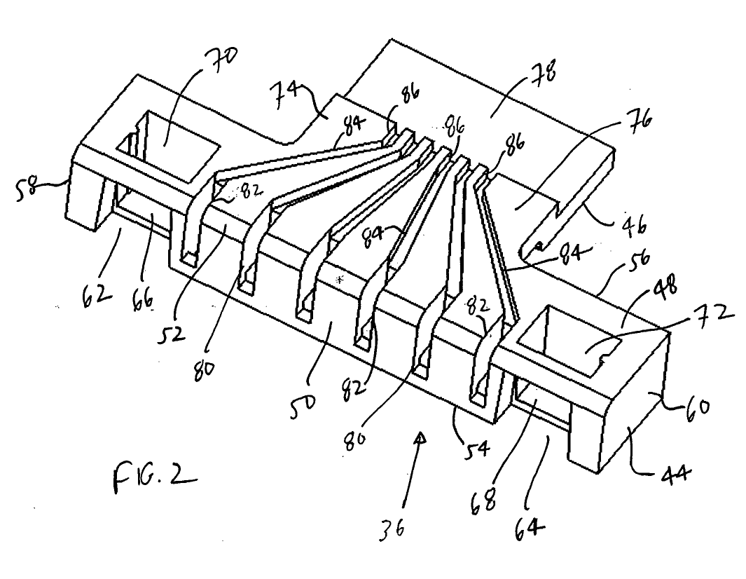

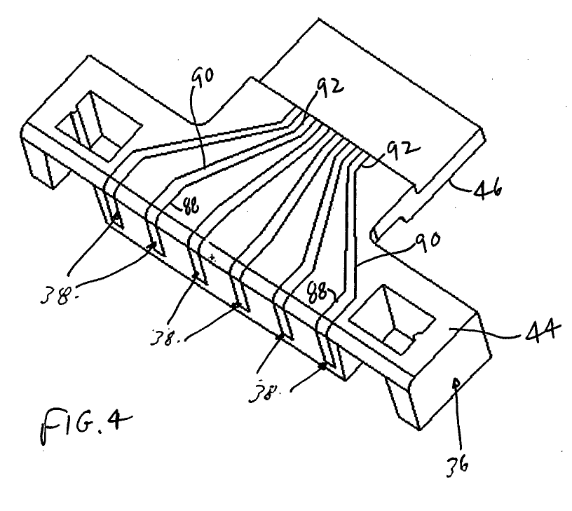

Attention is invited to FIGS. 1-7 which show the first embodiment of the interconnect device 20. To form the interconnect device 20 by a two shot molding process (which is one possible way to manufacture interconnect device 20), non-plateable plastic is shot in a first mold to form a non-plateable portion 36 as shown in FIG. 2. The non-plateable portion 36 is then transferred to a second mold and plateable plastic is selectively shot onto the non-plateable portion 36 to form plateable portions 38 as shown in FIG. 4. Thereafter, the plateable portions 38 are plated with a conductive material to form conductive pathways 40 in a known manner and clips 42 are attached to the non-plateable portion 36 to form the interconnect device 20 as shown in FIG. 1. Alternatively, the interconnect device 20 can be formed by molding the plateable material first, and then overmolding with a non-plateable material.

The non-plateable portion 36 formed in the first shot of the molding process includes a generally rectangular connector portion 44 with a generally rectangular base portion 46 extending perpendicularly therefrom at a midpoint thereof.

The connector portion 44 has a top surface 48, a front surface 50, a tapered surface 52 formed between the top and front surfaces 48, 50, a bottom surface 54, a rear surface 56 and end surfaces 58, 60. A pair of passageways 62, 64 are formed in the connector portion 44 proximate to, but spaced from, the end surfaces 58, 60. The passageways 62, 64 are open to the top surface 48, the front surface 50 and to the bottom surface 54. Walls 66, 68, which also form part of the bottom surface 54, partially close the bottom end of the respective passageways 62, 64 such that recesses 70, 72 are formed.

The base portion 46 has a first section 74 that has a top surface 76 that is flush with the top surface 48 of the connector portion 44 and a second section 78 that is stepped downwardly from the first section 74 such that it is parallel to, but offset from the first section 74.

As best illustrated in FIG. 2, elongated channels 80 are formed within the connector portion 44 and the first section 74 of the base portion 46 and extend downwardly from the top surfaces 48, 76 thereof a predetermined distance. The channels 80 further extend along the tapered surface 52 and the front surface 50 of the connector portion 44 inwardly a predetermined distance. The channels 80 are open to the bottom surface 54 of the connector portion 44. Each channel 80 starts at the front surface 50 of the connector portion 44 and terminates at the junction of the first section 74 of the base portion 46 to the second section 78 of the base portion 46. Each channel 80 is formed of a first portion 82 which is straight and extends inwardly from the front and tapered surfaces 50, 52 and between the top and bottom surfaces 48, 54, a second portion 84 which is angled relative to the first portion 82 and extends downwardly from the top surface 48 of the connector portion 44 and the base portion 46, and a third portion 86 which is straight and parallel to the first portion 82 and which extends downwardly from the top surface 48 of the connector portion 44 and the base portion 46. The first portions 82 are spaced apart from each other distances equal to the distances the terminals 34 on the connector 24 are spaced apart. The third portions 86 are spaced apart from each other distances equal to the spacing of the leads 28 on the sensor 22. The first portions 82 are spaced apart from each other distances that are substantially greater than the distances the third portions 86 are spaced apart. Because the non-plateable portion 36 is molded, mechanical components can be easily formed therein.

The second shot of molding which forms the plateable portions 38 of the interconnect device 20 is deposited into the channels 80 formed in the non-plateable portion 36. As a result and as best illustrated in FIG. 4, each plateable portion 38 is formed of a first portion 88, a second portion 90, and a third portion 92. The plateable portions 38 can substantially fill the channels 80 such that the top and front surfaces of the plateable portions 38 are flush with the surfaces of the non-plateable portion 36, or can extend beyond the surfaces of the non-plateable portion 38.

The conductive material, which forms the conductive pathways 40, plated onto the plateable portions 38 forms a deposit on the plateable portions 38. As a result, each conductive pathway 40 is formed of a first portion 94, a second portion 96, and a third portion 98.

As shown in FIG. 1, the clips 42 are formed of a first section 100 which is inserted into the recesses 70, 72 of the passageways 62, 64, a second section 103 which extends from the first section 100 along the rear surface 56, and a third section 102 which extends from the second section 103 and around the respective end surface 58, 60 and forwardly of the front surface 50. A second section 103 connects the first and third sections 100, 102 and is generally perpendicular to the third section 102 of the clip 42. The third sections 102 of the clips 42 engage the connector 24 for mating the interconnect device 20 and the connector 24 together. When engaged, the first portions 94 of the conductive pathways 40 abut against the terminals 34 in the connector 24 to form an electrical interconnection therebetween. Other means of mating the connector 24 to the interconnect device 20 are within the scope of the present invention.

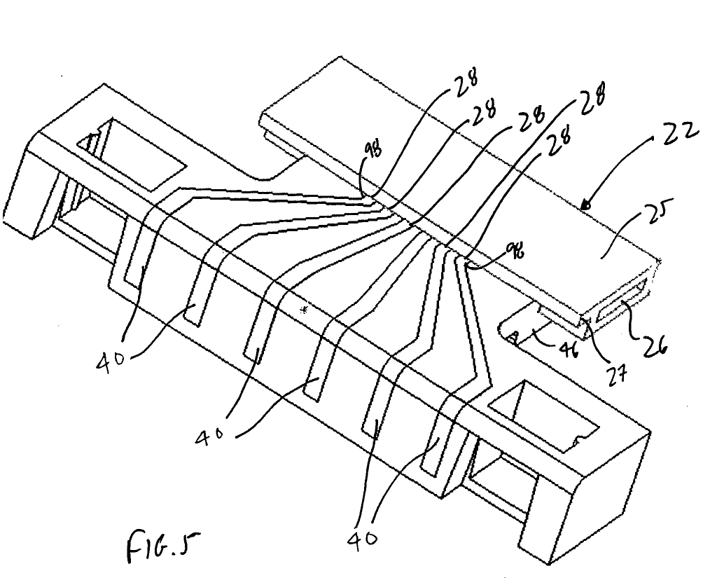

The third portions 98 of the conductive pathways 40 and the top surface of the connector portion 130 provided therearound define a solder or wire bond pad area. A solder paste (not shown) is deposited either on the leads 28 of the sensor 22 or on the third portions 98 of the conducive pathways 40 in the solder or wire bond pad area. The sensor 22 is positioned on the second section 78 of the base portion 46 as shown in FIG. 5, and secured thereto by adhesive (not shown). Thereafter, a reflow process is undertaken to melt the solder paste and to permanently mate the leads 28 of the sensor 22 to the third portions 98 of the conductive pathways 40 and to form an electrical interconnection therebetween. If desired, a ledge (not shown) can be formed at the rear end of the second section 78 of the base portion 46 to ensure accurate positioning of the sensor 22 relative to the conductive pathways 40.

Attention is now invited to FIGS. 8-16. The assembly 118 includes the interconnect device 120, a flow tube assembly 122, and the sensor 22.

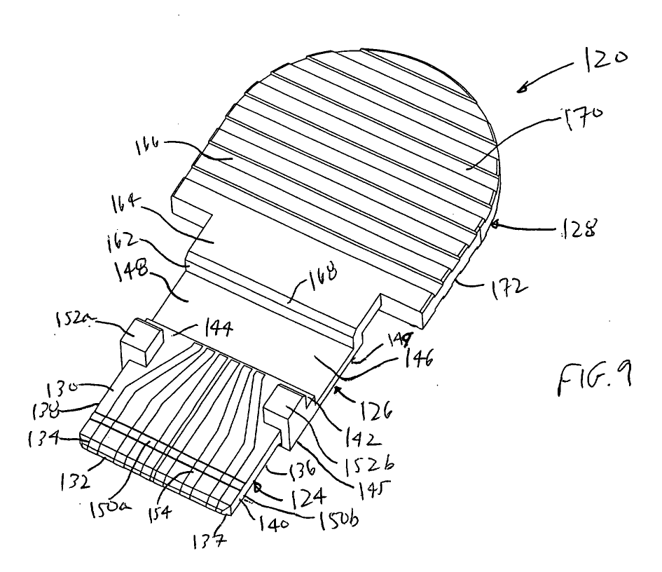

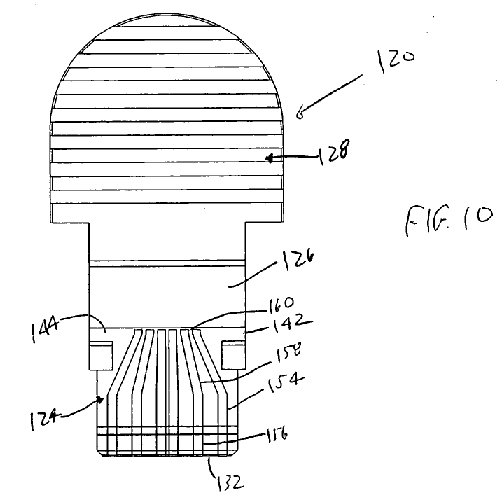

The interconnect device 120 is best illustrated in FIGS. 9 and 10 and includes a generally rectangular connector portion 124, a generally rectangular base portion 126 extending perpendicularly therefrom at a midpoint thereof, and a tab portion 128 extending from the base portion 126. The connector portion 124, the base portion 126 and the tab portion 128 may be integrally formed herein using a two-shot molding process and a plating process, as will hereinafter be described in further detail.

The connector portion 124 has a top surface 130, a front surface 132, an upper tapered surface 134 formed between the top and front surfaces 130, 132, a bottom surface 136, a bottom tapered surface 137 formed between the bottom and front surfaces 136, 132, and end surfaces 138, 140. A locking bump 150a, 150b is formed on the top surface 130 and on the bottom surface 136 of proximate to, but spaced from, the tapered surfaces 134, 137. Each locking bump 150a, 150b extends the entire width of the connector portion 124 between the end surfaces 138, 140.

The base portion 126 has a first section 142 which has a top surface 144 that is flush with the top surface 130 of the connector portion 124 and a bottom surface 145 that is stepped from the bottom surface 136 of the connector portion 124, and a second section 146 having a top surface 148 stepped downwardly from the top surface 144 of the first section 142 and a bottom surface 149 planar with the bottom surface 145 of the connector portion 124. A pair of shoulders 152a, 152b are formed on the front end of the first section 142 of the base portion 126. The shoulders 152a, 152b are generally cubically shaped and extend upwardly from the top surface 144 of the first section 142.

Conductive pathways 154 are formed along the connector portion 130 and the first section 142 of the base portion 126. The conductive pathways 154 extend generally from the front surface 132 to the rear edge of the first section 142 along the top and bottom surfaces 130, 144; 136, 145. The conductive pathways 154 extend over the locking bumps 150a, 150b. The conductive pathways 154 are generally flush with the surfaces 130, 132, 134, 136, 137, 144. As shown in FIG. 10, each conductive pathway 154 is formed of a first portion 156, a second portion 158, and a third portion 160 on the top and bottom surfaces 130, 144; 136, 145. Each first portion 156 extends generally straight from the front surface 132 toward the first section 142. Each third portion 160 extends generally straight from the rear edge of the first section 142 toward the front surface 132. Each second portion 158 extends between one of the first portions 156 and one of the third portions 160 and may extend either straight or at an angle depending on the desired position of the first portion 156, which must be spaced apart from each other distances equal to the distances the terminals on the connector 24 are spaced apart, and the desired position of the third portion 160, which must be spaced apart from each other distances equal to the spacing of the leads on the sensor 22. The tapered surfaces 134, 137 allow for easy connection to the mating connector 24. The third portions 160 of the conductive pathways 154 and the top surface 144 of the first section 142 provided therearound which are provided between the shoulders 152a, 152b and the rear end of the first section 142 define a solder or wire bond pad area.

The tab portion 128 has first, second and third sections 162, 164, 166. The first section 162 extends from a rear edge of the base portion 126 and is perpendicular thereto. The second section 164 extends from the upper edge of the first section 162 and is perpendicular thereto. The first and second sections 162, 164 have the same width as the base portion 126. A tapered edge 168 is provided between the first and second sections 162, 164. The third section 166 extends from the second section 164 and is planar with the second section 164. The third section 166 forms a finger grip and has an enlarged width relative to the second section 164. A height of the third section 166, defined as a distance from an upper surface 170 to a lower surface 172 thereof, alternates between a reduced height portion and an increased height portion along the length thereof.

The interconnect device 120 is preferably formed using a two-shot molding process and a plating process, although the present invention is not limited to such a forming method. Rather, any available manufacturing method used to manufacture electrical connection devices may also be used to manufacture the electrical interconnect 120.

To form the interconnect device 120 using a two-shot molding process, a plateable material, such as a liquid crystal polymer which is palladium doped, is shot in a first mold to form a plateable portion. The plateable portion includes most of the same parts of the interconnect device 120, which are provided on a smaller scale than the identical parts provided on the interconnect device 120. For instance, the plateable portion includes a scaled down version of the connector portion 124, the base portion 126 and the tab portion 128. The plateable portion, however, includes the conductive pathways 154 provided on the connector portion 124.

The plateable portion is then transferred to a second mold and a non-plateable material, such as silicone, is selectively shot in the second shot, using liquid injection molding (LIM), onto the plateable portion to form a non-plateable portion. The non-plateable material is overmolded onto all of the scaled down parts of the plateable portion, but does not cover those areas of the scaled down connector portion 124 and the base portion 126 at the location of the conductive pathways 154. The non-plateable material on the plateable portion gives the interconnect device 120 a spongy/textured feel to the user of the assembly 118.

Thus, the non-plateable portion constitutes the entire exposed/visible portion of the interconnect device 120, other than where the conductive pathways 154 are formed on the connector portion 124. Prior to the interconnect device 120 having the conductive pathways 154 formed thereon, portions of the plateable portion (hereinafter referred to as the traces (not shown)) are exposed/visible as they were not overmolded by the non-plateable material. The traces are then etched using suitable known means in order to expose the palladium of the plateable material. The plateable and non-plateable portions are then subjected to a plating process using known means in one or more metallicized baths, such as a copper bath, a nickel bath, a gold bath, etc., as desired in order to form the conductive pathways 154 onto the traces having the exposed palladium.

For methods of forming the interconnect device 120 other than two-shot molding, the portion of the interconnect device 120 identified as the conductive pathways 154 need merely be formed with a conductive material, and the remainder of the interconnect device 120 is formed with an insulative material.

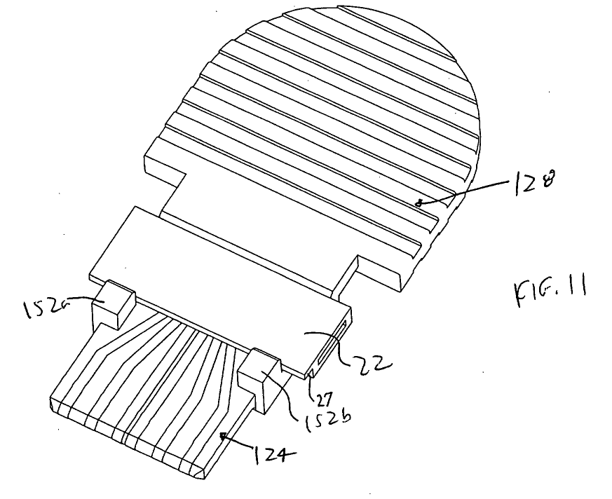

In use, a solder paste (not shown) is deposited either on the leads 28 of the sensor 22 or on the third portions 160 of the conducive pathways 154 in the solder or wire bond pad area. As shown in FIG. 11, the sensor 22 is positioned such that the main body 25 sits on the top surface 148 of the base portion 126 and abuts the first sections 142, 162. The main body 25 is secured to the base portion 126 by adhesive (not shown), and the lip 27 sits on the solder or wire bond pad of the first section 142. The free end of the lip 27 abuts against the shoulders 152a, 152b. The sensor 22 preferably has a width that is greater than the width of the base portion 126 such that end portions of the sensor 22 do not contact the base portion 126. Thereafter, a reflow process is undertaken to melt the solder paste and to permanently mate the leads 28 of the sensor 22 to the third portions 160 of the conductive pathways 154 and to form an electrical interconnection therebetween. It should be noted that the solder paste could have been deposited on the leads 28 of the sensor 22 rather than on the conductive pathways 154 of the connector portion 124, if desired.

The flow tube assembly 122 is preferably formed of plastic, such as PBT or polycarbonate. The flow tube assembly 122 is formed of hermaphroditic housing portions 174a, 174b, which may be hermaphroditic as set forth herein, which are mated together and a gasket 176 mounted within each housing 174a, 174b. One of the housings 174a is described, with the understanding that the other housing 174b is identical in construction and is denoted with identical reference numerals and having the suffix “b”. One of the gaskets 176 is described, with the understanding that the other gasket 176 has similar construction regarding the features relevant to the present invention.

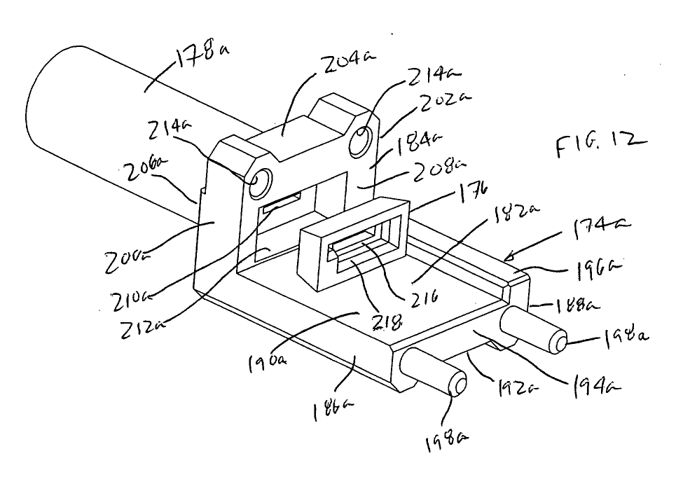

As shown in FIG. 12, the housing 174a has an L-shaped portion which has a tube 178a attached thereto. A passageway is provided through the tube 178a. The L-shaped portion has a first section 182a and a second section 184a that is perpendicular to the first section 182a. The tube 178a extends from the second section 184a and is perpendicular thereto. The first section 182a is generally rectangular and has a front surface 186a, a rear surface 188a, a top surface 190a, a bottom surface 192a and an end surface 194a. A shoulder 196a is provided on the top surface 190a and extends from the end surface 194a to the second section 184a. A pair of pins 198a extend from the end surface 194a proximate the edges thereof. The second section 184a is generally rectangular and has a front surface 200a, a rear surface 202a, a top surface 204a and end surfaces 206a, 208a. A passageway 210a extends through the second section 184a from the one end surface 206a to the other end surface 208a and is in fluid communication with the passageway in the tube 178a. A recess 212a is provided in the end surface 208a and surrounds the passageway 210a. A pair of apertures 214a are provided in the second section 184a from the one end surface 206a to the other end surface 208a proximate the edges thereof.

The gasket 176, which is preferably formed of an elastomeric material such as silicone, is insertable into the recess 212a and can be held therein by an interference fit or by mechanical means. A passageway 216 is provided therethrough and is in fluid communication with the passageway 210a in the second section 184a and the passageway in the tube 178a. A recess 218 surrounds the passageway 216 and extends from the surface facing the first section 182a inwardly a predetermined distance. The recess 218 has a shape that is identical to the profile of the end of the sensor 22 having the passageway 26.

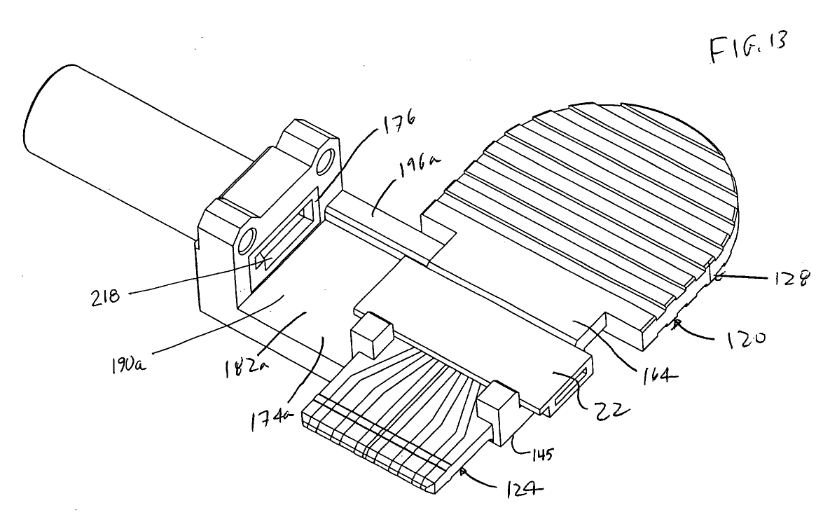

In use, a gasket 176 is inserted into the recess of each housing 174a, 174b as shown in FIG. 13. Alternatively, instead of forming each housing 174a, 174b and associated gasket 176 as separate members, the housing 174a, 174b may be formed in a first shot and the gasket 176 may be formed in a second shot. A suitable material which will allow silicone or another like resilient material to stick thereto is used as the first shot and silicone or another like resilient material is used as the second shot.

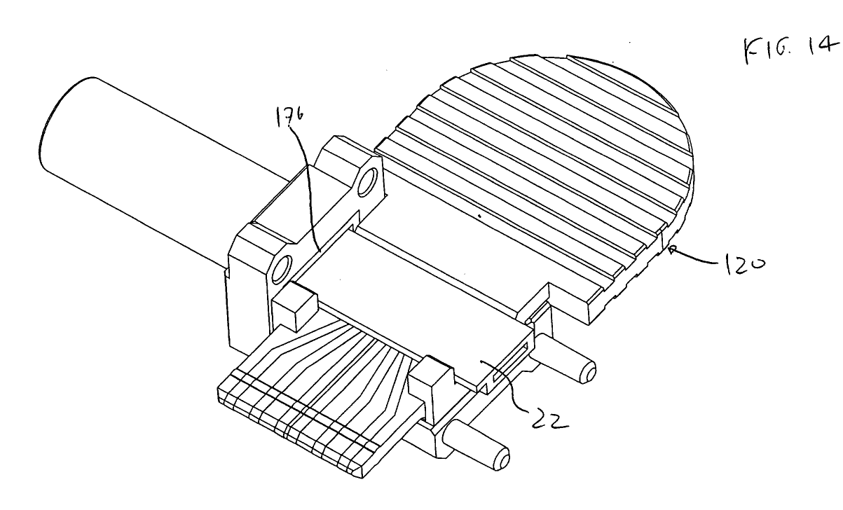

The interconnect device 120 which has the sensor 22 mounted thereon, is then engaged with one of the housings 174a as shown in FIGS. 13 and 14. The bottom surface 145 of the base portion 126 abuts against the top surface 190a of the first section 182a. The shoulder 196a abuts against the rear surface of the first section 162 and the bottom surface of the second section 164 of the tab portion 128. The end of the sensor 22 is seated within the recess 218 in the gasket 176 that forms a fluid-tight seal therebetween.

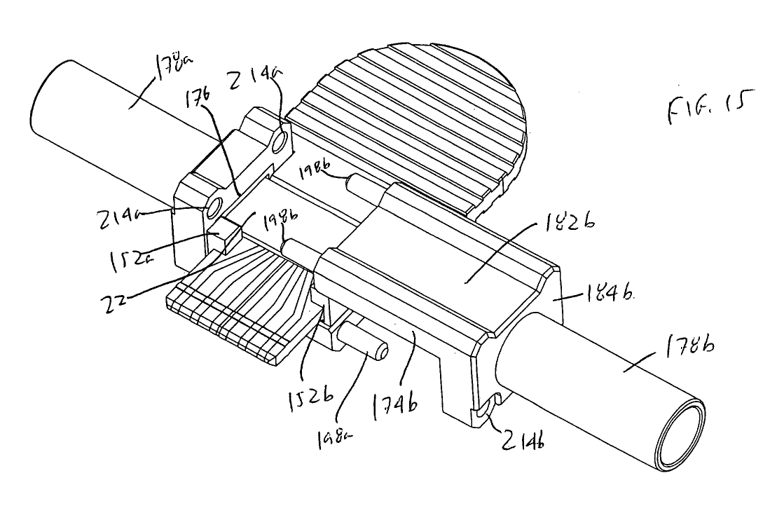

Thereafter, as shown in FIGS. 15 and 8, the other housing 174b is engaged with the housing 174a having the sensor 22 and interconnect device 120 mounted thereon. The free ends of the shoulders 152a, 152b engage the first section 182b of the other housing 174b. The pins 198a, 198b of the housings 174a, 174b engage with the opposing apertures 214a, 214b in the housings. The opposite end of the sensor 22 seats within the gasket in the other housing 174b. The interconnect device 120 and the sensor 22 are sandwiched between the housings 174a, 174b. The housings 174a, 174b are joined together by applying an axial force. The pins 198a, 198b can be heat staked or glued to the respective housings 174a, 174b to secure the connection of the housings 174a, 174b, or can be secured by an interference fit or other means for securing. Alternatively, the pins 198a, 198b can be eliminated and other means of attaching the housings 174a, 174b together can be provided, such as plastic latches 216b on one housing 174b which engage with shoulders 218a on the other housing 174a as shown in FIG. 17, metal clips and the like. A fluid-tight flow path is created from the tube 178a, through the housing 174a, through the gasket 176, through the sensor 22, through the gasket, through the other housing 174b and through the tube 178b. The fluid does not make contact with the interconnect device 120. Therefore, the interconnect device 120 can be formed from non-medical grade plastic.

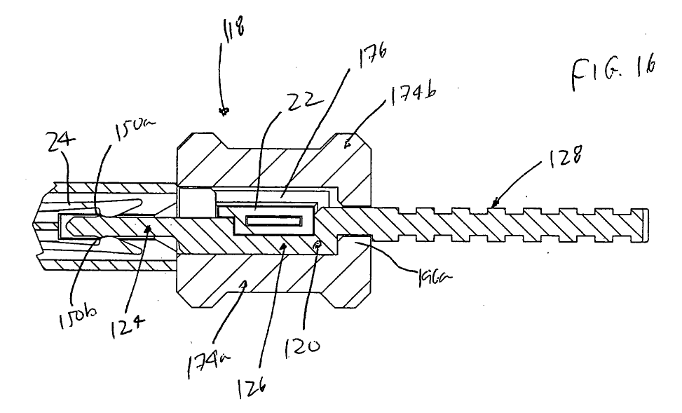

As shown in FIG. 16, the locking bumps 150a, 150a allow for retention to the mating connector 24.

Because the interconnect device 120 and the sensor 22 are mated together prior to being assembled with the flow tube assembly 122 this allows for non-high temperature material to be used for the flow tube assembly 122 since these components will not be subjected to the reflow process. In this second embodiment, soldering the sensor 22 to the interconnect device 120 prior to assembly with the housings 174a, 174b also provides for more accurate alignment of the leads on the sensor 22 to the conductive pathways 154 on the interconnect device 120 than the first embodiment.

The overmolding of the non-plated portions provides a mask for the areas to be plated and provides a user-friendly feel to the tab portion 128 of the interconnect device 120 that is to be handled by personnel during use of the assembly 118.

In an alternate embodiment as shown in FIG. 18, one end of the sensor 22 is sealed, such as by closing the passageway through the housing 174b such that a wall 220 is provided, or by providing a wall on the sensor 22 or by abutting a closed gasket against the end of the sensor 22. In this embodiment, the fluid is captured within the sensor 22 and characteristics of the fluid can be determined using same. The assembly 118 is then thrown away.

While a particular shape has been shown and described for the sensor 22, other shapes may be provided for the sensor 22. The gasket 176 would take on a corresponding shape.

As a result of the construction of the interconnect device 20, 120, the parasitic capacitance is minimal. The bulk of the capacitance results from the connector 24 to which the interconnect device 20, 120 is attached. This capacitance is not transmitted to the sensor 22, such that the capacitance generated by the connector 24 does not effect the sensor 22.

Other components can be easily formed on and added to the interconnect device 20, 120, such as resistor, capacitors, etc., if desired.

While six leads 28 are shown on the sensor 22, six conductive pathways 40, 154 are shown on the interconnect device 20, 120 and six terminals 34 are provided on the connector 24, it is to be understood that more or fewer leads 98, pathways 40, 154 and terminals 34 can be provided. In addition, a plurality of terminals 34 can be provided on the connector 24, with the pathways 40, 154 only contacting predetermined ones of the terminals 34, such that some of the terminals 34 are not used.

The two-shot molding process, which represents one possible way of forming the interconnect device 20, 120, allows for inexpensive manufacturing which is desirable as the assembly 118 is generally utilized as a throw away or disposable device. Also, the two-shot molding processes are amenable to being highly automated which is important, as the potential number of these assemblies 118 could be very high. The design of the assembly 118 can also be produced in a very cost effective manner through the use of parts consolidation and process step elimination.

As a result of the construction of the interconnect device 20, 120, the materials used to form the interconnect device 20, 120 can be opaque. This lessens the degradation of the electrical components than if the materials were transparent.

While preferred embodiments of the present invention are shown and described, it is envisioned that those skilled in the art may devise various modifications of the present invention without departing from the spirit and scope of the appended claims.

What is claimed is:

1. An assembly for mating to a connector comprising:
an interconnect device having a conductive pathway, said interconnect device being formed in two-shot molding process; and
a sensor mounted on said interconnect device, said sensor having a lead thereon, said lead being in electrical communication with said conductive pathway on said interconnect device.

2. An assembly as defined in claim 1, wherein said interconnect device includes a base portion onto which said sensor is partially seated, and a connector portion having said conductive pathway thereon.

3. An assembly for mating to a connector comprising:
an interconnect device having a conductive pathway; and
a sensor mounted on said interconnect device, said sensor having a lead thereon, said lead being in electrical communication with said conductive pathway on said interconnect device;
said interconnect device includes a base portion onto which said sensor is partially seated, a connector portion having said conductive pathway thereon, and a finger grip portion attached to said base portion, said finger grip portion being integrally formed with said base portion and said connector portion.

4. An assembly as defined in clam 1, further including a housing generally surrounding a portion of said interconnect device.

5. An assembly as defined in claim 4, wherein said housing is formed of first and second portions which mate together.

6. An assembly for mating to a connector comprising:
an interconnect device having a conductive pathway;
a housing generally surrounding a portion of said interconnect device, said housing being formed of first and second the hermaphroditic portions which mate together; and
a sensor mounted on said interconnect device, said sensor having a lead thereon, said lead being in electrical communication with said conductive pathway on said interconnect device.

7. An assembly as defined in claim 6, further including at least one flow tube attached to said housing.

8. An assembly as defined in claim 5, further including a gasket attached to each said housing portion for receiving respective ends of the sensor.

9. An assembly as defined in claim 8, wherein said gaskets are formed in said two-shot molding process.

10. An assembly as defined in claim 1, said interconnect device further including means for connecting said conductive pathway to a mating connector.

11. An assembly for mating to a connector comprising:
an interconnect device having a conductive pathway and locking bumps; and
a sensor mounted on said interconnect device, said sensor having a lead thereon, said lead being in electrical communication with said conductive pathway on said interconnect device

12. As assembly as defined in claim 1, wherein a plurality of conductive pathways are provided, each said conductive pathway has a first end for mating with a mating connector and a second end for mating with the sensor, the pitch between adjacent conductive pathways at a first end is different than the pitch between adjacent conductive pathways at a second end.

13. An assembly as defined in claim 6, wherein the interconnect device is formed by two-shot molding, the two-shot molding comprising a non-plateable shot and a plateable shot, the plateable shot being used to form the conductive pathway.

14. An assembly as defined in claim 13, wherein a conductive material is applied to the plateable portion of the interconnect device to form the conductive pathway.

15. An assembly for mating to a connector comprising:
an interconnect device having a conductive pathway;
a housing generally surrounding a portion of said interconnect device, said housing being formed of first and second portions which mate together;
a sensor mounted on said interconnect device, said sensor having a lead thereon, said lead being in electrical communication with said conductive pathway on said interconnect device, the sensor having an opening at each end forming a passageway through the sensor; and
said first housing portion includes a gasket for receiving an end of the sensor, said second housing portion includes a gasket for receiving an opposite end of the sensor, and at least one of the gaskets includes an opening therethrough that is in line with the sensor passageway.

16. An assembly as defined in claim 8, wherein each said gasket includes a recess that is shaped to be identical to an end profile of the sensor.

17. An assembly as defined in claim 15, wherein the interconnect device is not in contact with the sensor passage way.

18. An interconnect device capable of connecting a sensor to a connector comprising:
a base portion on which the sensor can be seated; and
a connector portion having a conductive pathway thereon, and
the interconnect device is formed in a two-shot molding process.

19. An interconnect device as defined in claim 18, wherein said base portion and said connector portion are integrally formed.

20. (canceled)

21. An interconnect device capable of connecting a sensor to a connector comprising:
a base portion on which the sensor can be seated;
a finger grip portion attached to said base portion; and
a connector portion having a conductive pathway thereon.

22. An interconnect device as defined in claim 21, wherein said finger grip portion is integrally formed with said base portion and said connector portion in a two-shot molding process.

23. An interconnect device as claimed in claim 18, further including a housing generally surrounding said base portion.

24. An interconnect device as defined in claim 23, further including at least one flow tube attached to said housing.

25. An interconnect device as defined in claim 23, wherein said housing is formed of two portions which mate together.

26. An interconnect device capable of connecting a sensor to a connector comprising:
a base portion on which the sensor can be seated;
a housing generally surrounding said base portion, said housing being formed of two hermaphroditic portions which mate together; and
a connector portion having a conductive pathway thereon.

27. An interconnect device as defined in claim 25, further including a gasket attached to each said portion.

28. An interconnect device as defined in claim 27, wherein said portions and said gaskets are formed in a two-shot molding process.

29. An interconnect device as claimed in claim 18, further including means for connecting said connector portion to a connector.

30. An interconnect device capable of connecting a sensor to a connector comprising:
a base portion on which the sensor can be seated; and
a connector portion having a conductive pathway and locking bumps thereon.
